(19) United States
(12) Patent Application Publication
(10) Pub. No.: US 2026/0197096 A1
(43) Pub. Date: Jul. 9, 2026

(54) SPREAD SPECTRUM CLOCKING SETTINGS ADJUSTING METHOD AND WIRELESS PACKET RECEIVING METHOD

(71) Applicant: Realtek Semiconductor Corporation, Hsinchu (TW)

(72) Inventor: Wei Chen LIU, Hsinchu (TW)

(21) Appl. No.: 19/420,768

(22) Filed: Dec. 16, 2025

(30) Foreign Application Priority Data
Jan. 3, 2025 (TW) 114100376

(51) Int. Cl. H04B 15/04; H04B 1/69

(52) U.S. Cl. CPC H04B 15/04; H04B 1/69; H04B 2215/065

(57) ABSTRACT

A spread spectrum clocking (SSC) settings adjusting method includes: expanding candidate SSC settings for a system scenario; applying the candidate SSC settings to an integrated circuit (IC) device that stores a predefined look-up table (LUT); measuring candidate signal-to-noise ratios (SNRs) of the IC device respectively under the candidate SSC settings; selecting a selected SSC setting that has a highest SNR of the candidate SNRs from the candidate SSC settings corresponding to the system scenario; and substituting an SSC setting of the predefined LUT corresponding to the system scenario with the selected SSC setting, so as to update the predefined LUT stored in the IC device.

### RELATED APPLICATIONS

This application claims priority to Taiwan Application Serial Number 114100376, filed January 3, 2025, which is herein incorporated by reference.

### BACKGROUND

### Technical Field

The present disclosure relates to a spread spectrum clocking (SSC) setting for packet receiving. More particularly, the present disclosure relates to a spread spectrum clocking settings adjusting method and a wireless packet receiving method.

### Description of Related Art

With the progress of semiconductor industry, multiple functional circuits (such as computing circuits, memory circuits, communication-related circuits, and image processing circuits) and electronic components can be fabricated in the same IC device. However, for an IC device that integrates with a high-speed interface and/or a high-speed volatile memory, the electromagnetic interference generated by the high-speed interface and/or the high-speed volatile memory may cause a serious impact on wireless communications. Especially, when receiving packets, if the clear channel assessment (CCA) threshold needs to be increased due to electromagnetic interference, the wireless communication circuit is probably unable to detect low-energy signals and incorrectly receive interference signals, thus resulting in deterioration of wireless communication quality.

In addition, since a wireless communication network may span channels or even frequency bands, if only the interference source is frequency-shifted in a specific channel, additional interferences with other channels may be coupled, and the throughput of the high-speed interface or memory is probably reduced so that the system transmission or computation requirement can not be satisfied. In addition to that, if a fixed spread spectrum setting is only applied to the interference source, although the interference with a specific channel can be reduced, the signal-to noise ratios (SNRs) of other channels may be reduced to affect the wireless transmission quality.

### SUMMARY

An SSC settings adjusting method is provided. The SSC settings adjusting method includes: expanding candidate SSC settings for a system scenario; applying the candidate SSC settings to an IC device that stores a predefined look-up table (LUT); measuring candidate SNRs of the IC device respectively under the candidate SSC settings; selecting a selected SSC setting that has a highest SNR of the candidate SNRs from the candidate SSC settings corresponding to the system scenario; and substituting an SSC setting of the predefined LUT corresponding to the system scenario with the selected SSC setting, so as to update the predefined LUT stored in the IC device.

The present disclosure provides a wireless packet receiving method adapted for an IC device. A non-volatile memory (MVM) of the IC device stores the above predefined LUT. The wireless packet receiving method includes: initializing a wireless communication circuit of the IC device based on a system scenario; selecting a wireless channel used for wireless transmission through the wireless communication circuit; adopting an SSC setting correspondingly according to a system clock profile in the system scenario by referring to the predefined LUT; and controlling the wireless communication circuit to receive a packet via the wireless channel.

The present disclosure further provides an SSC settings adjusting method. The SSC settings adjusting method includes: expanding a plurality of candidate SSC settings for a system scenario; applying the candidate SSC settings to each of IC devices that stores a predefined LUT; measuring candidate SNRs of each of the IC devices respectively under the candidate SSC settings; selecting a selected SSC setting that has a highest SNR of the candidate SNRs from the candidate SSC settings corresponding to the system scenario for each of the IC devices; and adjusting the predefined LUT according to the selected SSC setting corresponding to each of the IC devices, so as to update the predefined LUT stored in each of the IC devices.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 is a schematic diagram of a circuit block of an IC device in accordance with some embodiments of the present disclosure.

FIG. 2 is an example of a system register and an interference source status recorder in the IC device of FIG. 1.

FIG. 3 is a flowchart of a method for establishing a predefined LUT in accordance with some embodiments of the present disclosure.

FIG. 4 illustratively shows possible options for constituting a system scenario.

FIG. 5 illustratively shows possible options for constituting an SSC setting.

FIG. 6 is an example of a predefined LUT obtained by performing the method for establishing the predefined LUT in FIG. 3.

FIG. 7 is a schematic flowchart of an SSC settings adjusting method in accordance with some embodiments of the present disclosure.

FIG. 8 is a schematic flowchart of an SSC settings adjusting method in accordance with some embodiments of the present disclosure .

FIG. 9 is a schematic flowchart of a wireless packet receiving method in accordance with some embodiments of the present disclosure.

FIG. 10 is a schematic flowchart of a wireless packet receiving method in accordance with some embodiments of the present disclosure.

FIG. 11 is a schematic flowchart of a wireless packet receiving method in accordance with some embodiments of the present disclosure.

FIG. 12 is a schematic flowchart of a wireless packet receiving method in accordance with some embodiments of the present disclosure.

### DETAILED DESCRIPTION

The embodiments of the present disclosure are discussed in detail below. It will be appreciated, however, that the embodiments provide many applicable concepts that can be embodied in a wide variety of specific contexts. The embodiments discussed and disclosed are for illustration only and are not intended to limit the scope of the present disclosure.

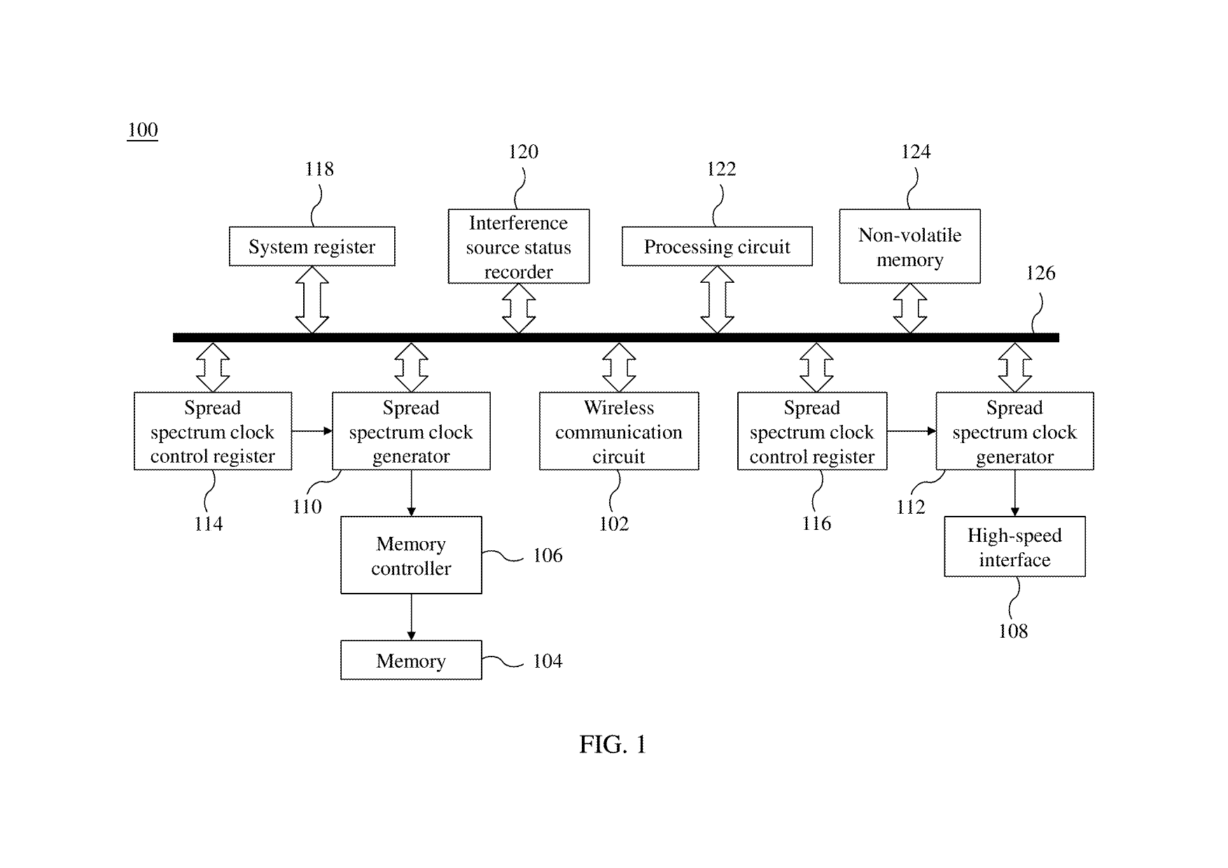

FIG. 1 is a schematic diagram of a circuit block of an IC device 100 in accordance with some embodiments of the present disclosure. The IC device 100 may be an integral circuit chip, such as a system-on-chip (SoC), or a system-in-package (SIP) component or a chip-on-board (COB) component, but the present disclosure is not limited in this regard. As shown in FIG. 1, the IC device 100 includes a wireless communication circuit 102, a memory 104, a memory controller 106, a high-speed interface 108, spread spectrum clock generators 110 and 112, spread spectrum clock control registers 114 and 116, a system register 118, an interference source status recorder 120, a processing circuit 122, an NVM 124, and a bus 126. In addition, the IC device 100 may further include another high-speed hardware block, such as an image signal processor (ISP), an encoder, a neural network (NN) circuit, a media access control (MAC) circuit, and/or a co-processor.

The wireless communication circuit 102 may support one or more generations of wireless communication technologies, such as Wi-Fi, cellular communication, and/or Bluetooth. In some embodiments, the IC device 100 includes wireless communication circuits 102, such as a Wi-Fi circuit, a Bluetooth circuit, a cellular communication circuit, a ZigBee circuit, and/or a near-field communication (NFC) circuit, which respectively support different wireless communication technologies.

The memory 104 is configured to temporarily store data when the IC device 100 is operating. The memory 104 may be a volatile memory, such as a dynamic random access memory (DRAM). The memory controller 106 is coupled to the memory 104 and is configured to write data into or read data from the memory 104 according to a control instruction on the bus 126.

The high-speed interface 108 serves as an interface for high-speed data transmission between the IC device 100 and some other components (such as a solid-state drive and a display) The high-speed interface 108 may be, for example, a USB3 interface, a PCIe interface, a SATA interface, a Thunderbolt interface, but the present disclosure is not limited in this regard. Additionally, the IC device 100 may have high-speed interfaces 108, and is not limited to the single high-speed interface 108 shown in FIG. 1.

The spread spectrum clock generators 110 and 112 are respectively coupled to the memory 106 and the high-speed interface 108 and are respectively configured to generate spread spectrum processed clocks for the memory 104 and the high-speed interface 108. In addition to that, the spread spectrum clock control registers 114 and 116 are respectively configured to adjust the SSC settings of the memory 104 and the high-speed interface 108.

The system register 118 is configured to store control bits of various components (including the memory 104, the high-speed interface 108, and the processing circuit 122) correspondingly, and the interference source status recorder 120 is configured to record states of various interference sources (such as the memory 104, the high-speed interface 108, and the processing circuit 122) in the IC device 100 that affects the wireless communication circuit 102.

The processing circuit 122 is configured to perform data computing tasks on the IC device 100. The processing circuit 122 may be, for example, a central processing unit (CPU), a microprocessor, a graphic processing unit (GPU), an application specific integrated circuit (ASIC), but the present disclosure is not limited in this regard.

The NVM 124 is configured to store program instructions executed by the processing circuit 122 or data accessed by the processing circuit 122. The NVM 124 may be, for example, a multi-chip module (MCM) flash memory, an eFuse memory, a one-time programmable (OTP) memory, or another suitable memory.

The bus 126 is coupled to various components in the IC device 100, which include the wireless communication circuit 102, the memory 104, the memory controller 106, the high-speed interface 108, the spread spectrum clock generators 110 and 112, the spread spectrum clock control registers 114 and 116, the system register 118, the interference source status recorder 120, the processing circuit 122, and the NVM 124, and is configured to control signal transmissions among the above components. The bus 126 may be, for example, an advanced peripheral bus (APB), an advanced extensible interface (AXI), an advanced high-performance bus (AHB), or any combination of the above components, but the present disclosure is not limited thereto.

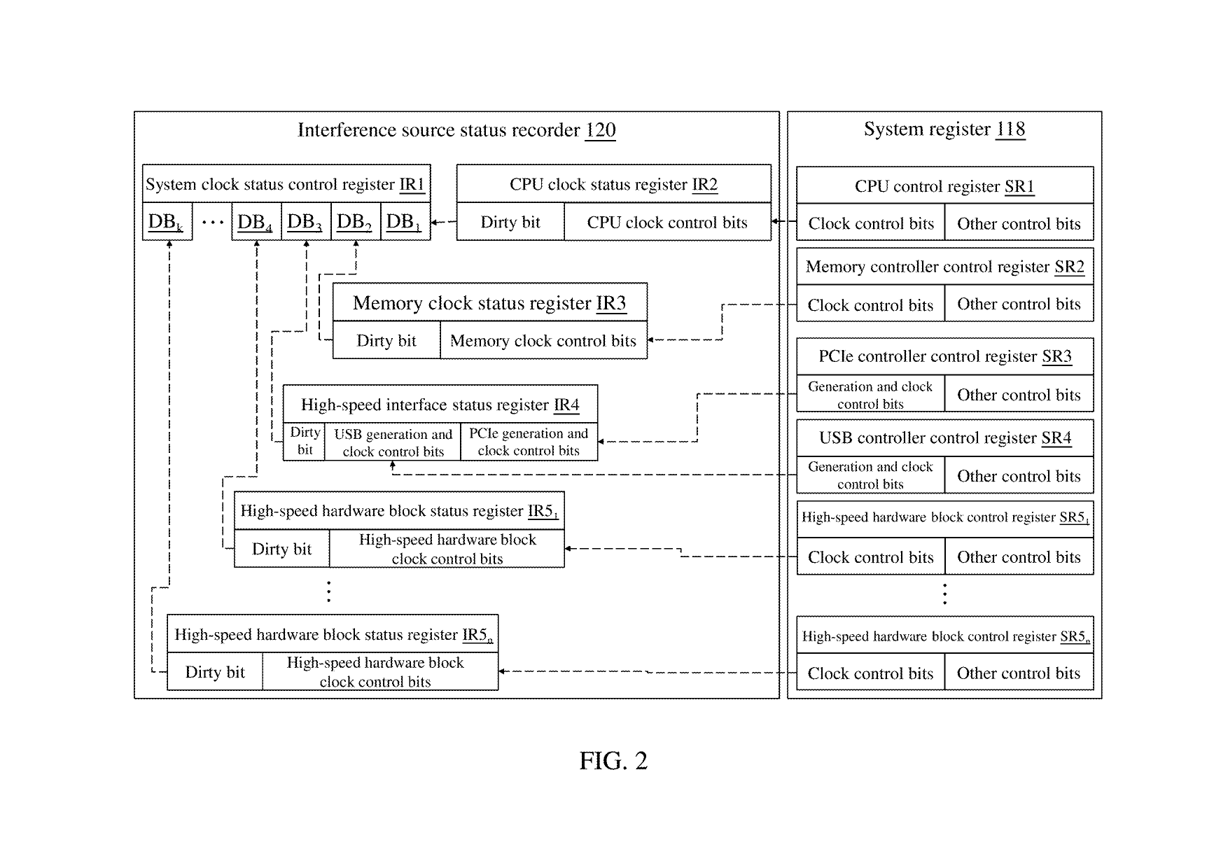

FIG. 2 is an example of the system register 118 and the interference source status recorder 120 in the IC device 100 of FIG. 1. In the example of FIG. 2, the system register 118 includes a CPU control register SR1, a memory controller control register SR2, a PCIe controller control register SR3, a USB controller control register SR4, and 1^{st} to n^{th} high-speed hardware block control registers SR5₁–SR5ₙ. The interference source status recorder 120 includes a system clock status control register IR1, a CPU clock status register IR2, a memory clock status register IR3, a high-speed interface status register IR4, and high-speed hardware block status registers IR5₁–IR5ₙ.

In the system register 118, each of the registers stores control bits, in which the control bits stored by the CPU control register SR1, the USB controller control register SR4, and the 1^{st} to n^{th} high-speed hardware block control registers SR5₁–SR5ₙ include clock control bits (which are used to control clock rates) and some other control bits (such as control bits used to turn on or turn off hardware correspondingly). Control bits stored by the memory controller control register SR2 and the PCIe controller control register SR3 include generation and clock control bits (which are used to control generation specifications and clock rates) and some other control bits (such as control bits used to turn on or turn off hardware correspondingly).

In the interference source status recorder 120, the CPU clock status register IR2, the memory clock status register IR3, and the high-speed hardware block status registers IR5₁–IR5ₙ map to the clock control bits stored in the CPU control register SR1, the memory controller control register SR2, and the 1^{st} to n^{th} high-speed hardware block control registers SR5₁–SR5ₙ, respectively, and the high-speed interface status register IR4 maps to the clock control bits stored in the PCIe controller control register SR3 and the USB controller control register SR4. In addition, each of the CPU clock status register IR2, the memory clock status register IR3, the high-speed interface status register IR4, and the high-speed hardware block status registers IR5₁–IR5ₙ includes a dirty bit for indicating whether the corresponding clock control bits are changed or not. For example, if a CPU clock rate changes, a value of the clock control bit of the CPU control register SR1 also changes correspondingly, and a value of the dirty bit of the CPU clock status register IR2 is changed from 0 to 1. The system clock status control register IR1 includes dirty bits DB₁–DBₖ, which respectively map to the dirty bits of the CPU clock status register IR2, the memory clock status register IR3, the high-speed interface status register IR4, and the high-speed hardware block status registers IR5₁–IR5ₙ.In a complex system or, for example, a configuration where multiple cores of a multi-thread and a multi-core processor operate simultaneously, the system clock status control register IR1 can accurately know the interference source of the clock rate change in a real-time manner and perform subsequent processing accordingly.

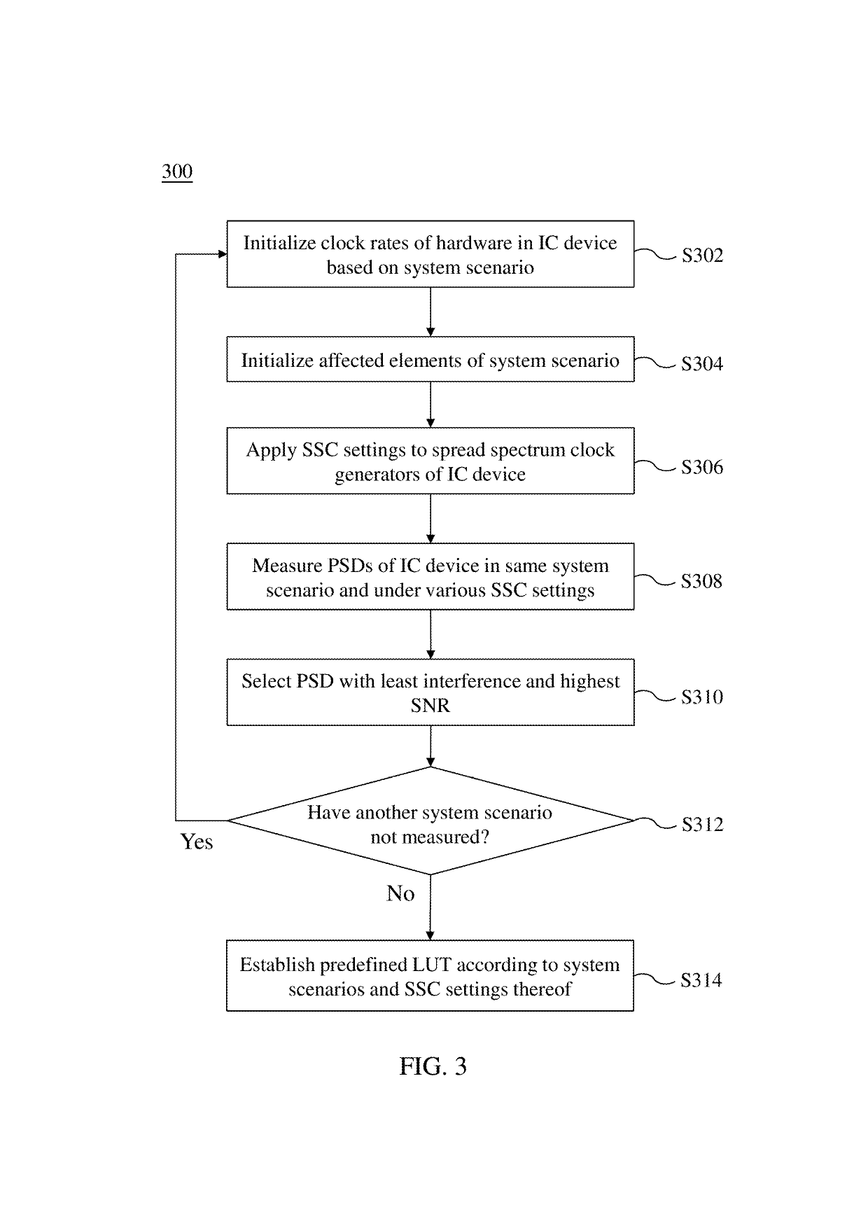

FIG. 3 is a flowchart of a method 300 for establishing a predefined LUT in accordance with some embodiments of the present disclosure. The method 300 for establishing the predefined LUT can be used in the sample testing stage of an IC device. First, Operation S302 is performed to initialize clock rates of hardware in the IC device based on a system scenario, and Operation S304 is performed to initialize affected elements of the system scenario. The system scenario may include interference sources (hardware) that may affect wireless communication function and their configurations (such as whether the status is turned on/turned off and the clock rate used), and the affected elements may be elements whose wireless transmission and reception performance is affected due to the interference sources.

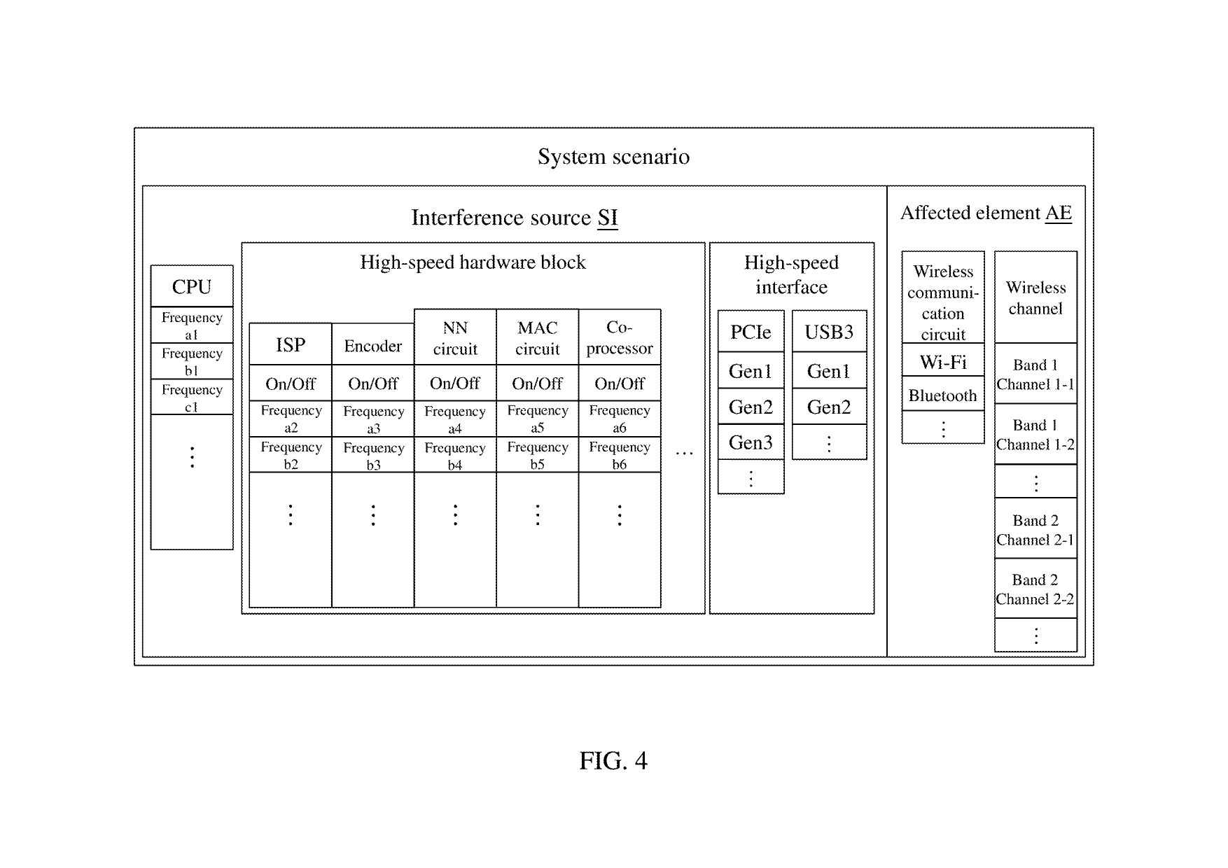

For example, FIG. 4 illustratively shows possible options for constituting a system scenario, in which interference source SI may include video-related hardware, such as a CPU, a high-speed hardware block, and a high-speed interface, and/or other hardware that may interfere with wireless transmission and reception, and affected element AE may include a wireless communication circuit and/or a wireless channel. The CPU can operate at different clock rates (also called frequencies), such as Frequency a1, Frequency b1, and Frequency c1. The high-speed hardware block includes an ISP, an encoder, an NN circuit, an MAC circuit, and/or a co-processor, but the present disclosure is not limited thereto. In the present example, the statuses of the ISP, the encoder, the NN circuit, the MAC circuit, and the co-processor may be all on, all off, or partially on and partially off, and the ISP can operate at Frequency a2, Frequency b2, or another frequency. The encoder can operate at Frequency a3, Frequency b3, or another frequency. The NN circuit can operate at Frequency a4, Frequency b4, or another frequency. The MAC circuit can operate at Frequency a5, Frequency b5, or another frequency, and the co-processor can operate at Frequency a6, Frequency b6, or another frequency. The high-speed interface may be a PCIe interface or a USB3 interface, in which the PCIe interface may be first generation (Gen1), second generation (Gen2), third generation (Gen3), or a more advanced generation, and the USB3 interface may be first generation (Gen1), second generation (Gen2), or a more advanced generation. The wireless communication circuit may be a Wi-Fi circuit, a Bluetooth circuit, or another circuit with wireless communication function (such as a cellular communication circuit, a ZigBee circuit, and/or an NFC circuit), and the wireless channel may be channel information used when the wireless communication circuit performs signal transmission and reception, which includes Channels 1-1 and 1-2 of Band 1, Channels 2-1 and 2-2 of Band 2, another channel, and combinations thereof. For example, the affected wireless communication circuit may be a Wi-Fi circuit, and the wireless channel correspondingly affected may be, for example, Channel 1 (with the center frequency of 2.142 GHz), Channel 2 (with the center frequency of 2.147 GHz) of a 2.4 GHz frequency band, Channel 36 (with the center frequency of 5.180 GHz) of a 5 GHz frequency band, Channel 40 (with the center frequency of 5.200 GHz), and/or one or more channels of a 6 GHz frequency band, but the present disclosure is not limited thereto.

After Operation S302 and Operation S304 are completed, Operation S306 is then performed to apply SSC settings to spread spectrum clock generators of the IC device (which is used to generate, for example, a memory clock signal and/or a high-speed interface clock signal) to adjust clock rates of hardware, such as a memory and/or a high-speed interface. Taking being used in the IC device 100 for example, Operation S306 may be to change SSC settings of the spread spectrum clock generator 110 and/or the spread spectrum clock generator 112.

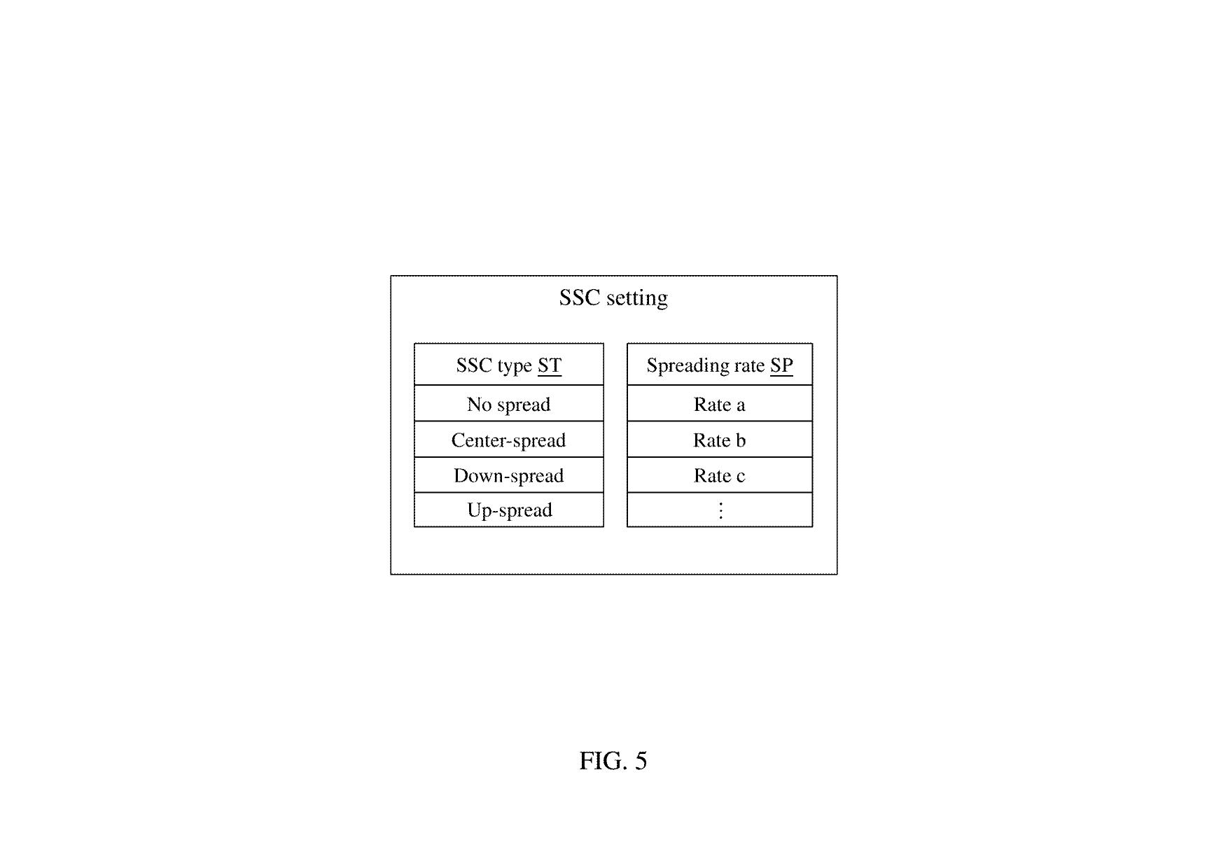

The SSC setting includes an SSC type and a spreading rate. FIG. 5 illustratively shows possible options for constituting the SSC setting, in which the SSC type ST includes no spread (no spread spectrum process is performed), center-spread (the center frequency remains substantially unchanged), down-spread (the center frequency changes downwards), and up-spread (the center frequency changes upwards), and the spreading rate SP (including Rate a, Rate b, and Rate c) is a ratio of a spread spectrum width to a center frequency of a system clock profile (such as 1%, 1.5%, or another value).

Next, Operation S308 is performed. The power spectral densities (PSDs) of the IC device in the same system scenario and under various SSC settings are measured. The PSDs can be obtained by using a measuring device to measure the wireless signal sent by the wireless communication circuit. The measuring device may be, for example, a spectrum analyzer, a vector signal analyzer, but the present disclosure is not limited thereto.

After that, Operation S310 is performed. From all the power spectral densities (PSDs), the one with least interferences and a highest SNR is selected. By performing Operations S302–S310, an SSC setting with a highest power spectrum density in this system scenario can be obtained. Since there may be several system scenarios in the actual application of the IC device, Operations S302–S310 can be performed for each of the system scenarios. After Operation S310 is completed, Operation S312 is thereafter performed to determine whether there is another system scenario that has not been measured or not. If there is the another system scenario that has not been measured, then the flow returns to Operations S302–S310 to obtain an SSC setting corresponding to the another system scenario. After SSC settings of all system scenarios are obtained (which means that all the system scenarios have been measured), the flow proceeds to Operation S314 to establish the predefined LUT according to the system scenarios and their SSC settings. The established predefined LUT is used for the stage of subsequent mass production of the IC device, and is, for example, stored in an NVM of the IC device, or programmed as program codes executed by the IC device.

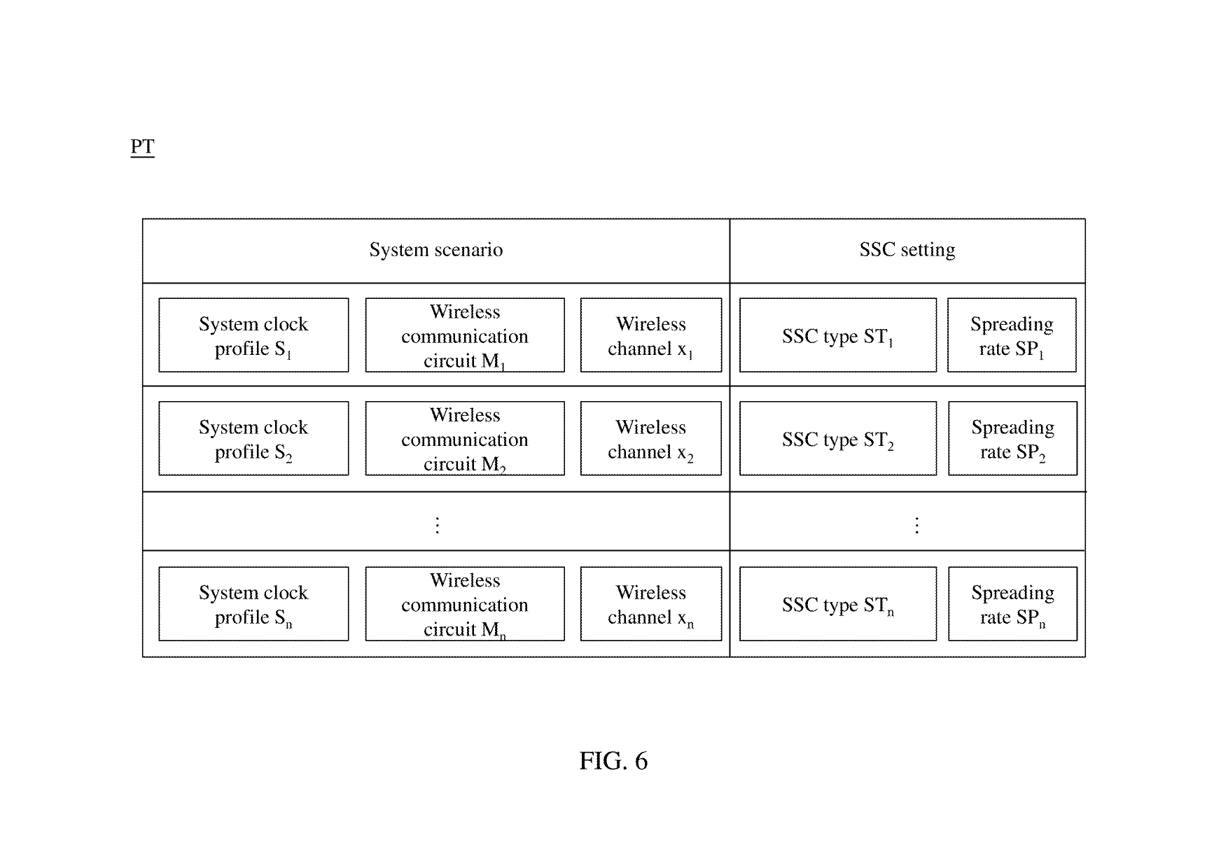

FIG. 6 is an example of a predefined LUT PT obtained by performing the method 300 for establishing the predefined LUT. As shown in FIG. 6, the predefined LUT PT includes fields, such as system scenarios and SSC settings. Each of system scenario fields is defined by information, such as an interference source and affected elements, and each SSC setting field is defined by SSC setting information, which includes an SSC type and a spreading rate. In each of the system scenario fields, interference source information includes a system clock profile, and the corresponding affected elements include a wireless communication circuit and a wireless channel.

In FIG. 6, n system scenario fields respectively correspond to n SSC setting fields. For example, a system scenario including a system clock profile S₁, a wireless communication circuit M₁, and a wireless channel x₁ corresponds to an SSC setting field including an SSC type ST₁ and a spreading rate SP₁, and a system scenario including a system clock profile S₂, a wireless communication circuit M₂, and a wireless channel x₂ corresponds to an SSC setting field including an SSC type ST₂ and a spreading rate SP₂, and so forth. Each of the system clock profiles S₁–S₂ and system clock profiles S₃–Sₙ may be a specific hardware operating at a specific frequency.

It should be noted that the system clock profiles, wireless communication circuits, and wireless channels of different system scenario fields may be partially different or completely different, and the SSC types and spreading rates of different SSC setting fields may be partially different, completely different or completely the same. In one example, the system clock profile S₁ and the wireless channel x₁ are different from the system clock profile S₂ and the wireless channel x₂, respectively, and the wireless communication circuit M₁ is the same as the wireless communication circuit M₂ (which represents the influence on the same wireless communication circuit caused by different system clock profiles to perform signal reception in different wireless channels).

An initial predefined LUT obtained by performing the method 300 for establishing the predefined LUT can be directly used in a production line to mass-produce the IC device, or may be adjusted first and then used in a production line to mass-produce the IC device.

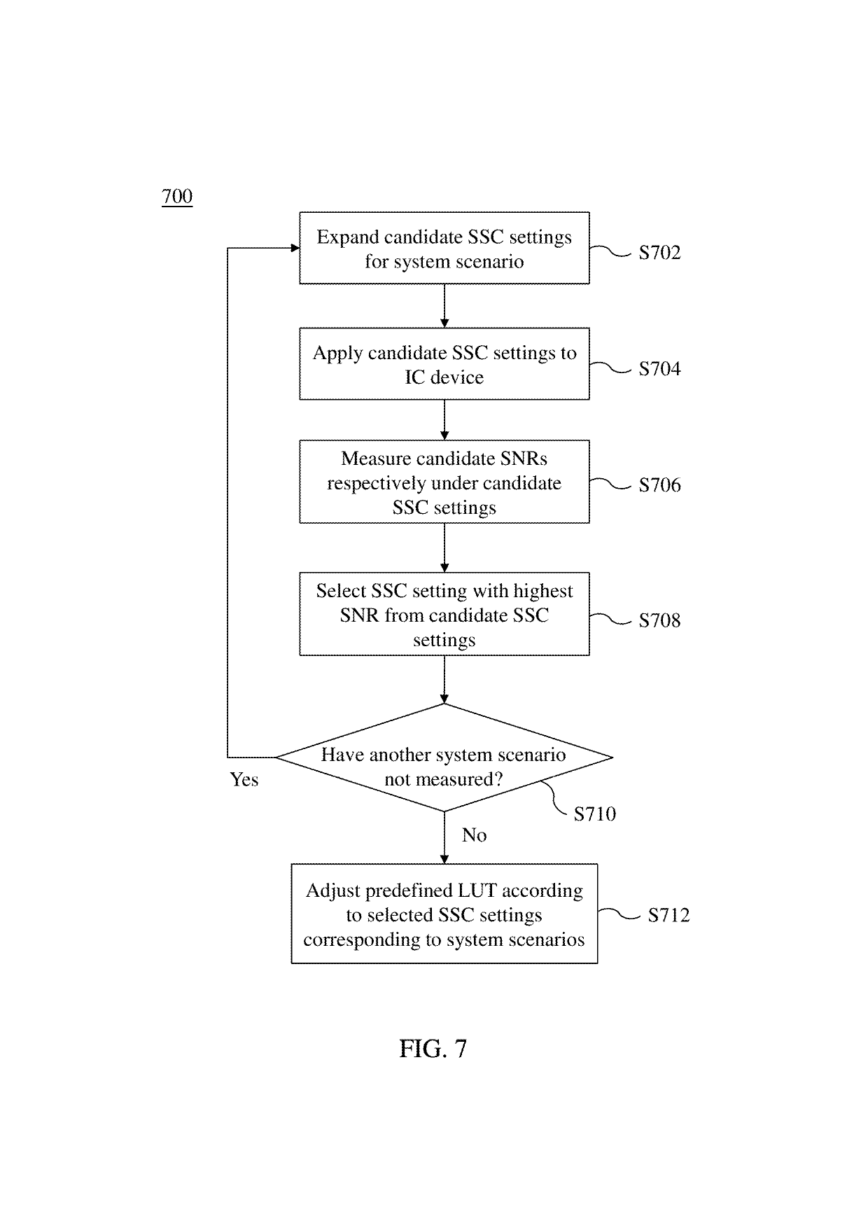

In some embodiments, the predefined LUT can be first written into the NVM of each of IC devices, and then each of the IC devices is measured to adjust the SSC settings in the predefined LUT of each of the IC devices. FIG. 7 is a schematic flowchart of an SSC settings adjusting method 700 in accordance with some embodiments of the present disclosure. First, Operation S702 is performed to expand candidate SSC settings for a system scenario. Next, Operation S704 is performed to apply the candidate SSC settings to an IC device. Then, Operation S706 is performed to measure candidate SNRs of the IC device respectively under the candidate SSC settings. After Operation S706 is completed, Operation S708 is thereafter performed to select a selected SSC setting that has a highest SNR corresponding to the system scenario from the candidate SSC settings. After that, Operation S710 is performed to determine whether there is another system scenario that has not been measured or not. If there is the another system scenario that has not been measured, the flow returns to Operation S702 to Operation S708 to select the selected SSC setting that has the highest SNR corresponding to the another system scenario. After selecting the selected SSC settings that have the highest SNRs corresponding to all system scenarios, Operation S712 is performed to adjust the predefined LUT according to the selected SSC setting corresponding to each of the system scenarios. That is, SSC settings corresponding to the system scenarios in the predefined LUT stored in the NVM are substituted with the selected SSC settings corresponding to the system scenarios, respectively, so as to update the predefined LUT.

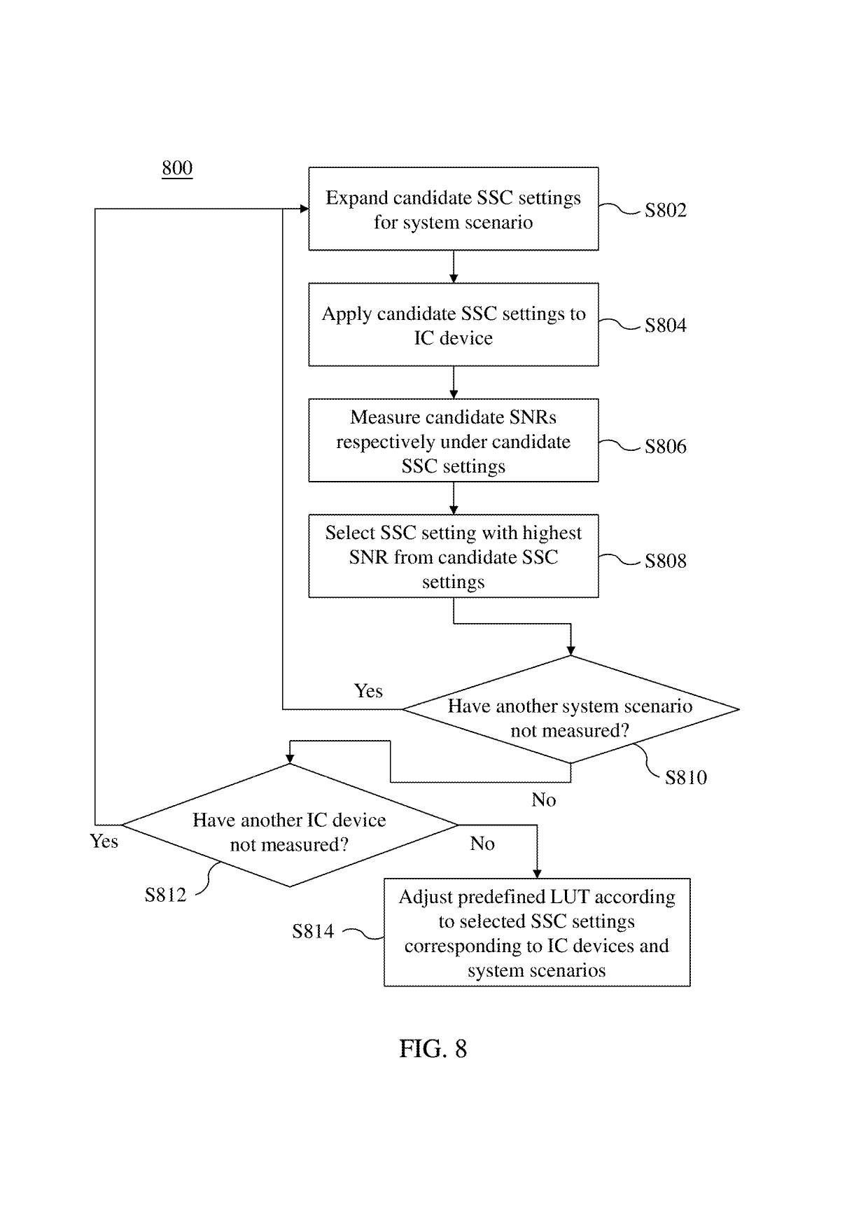

In some other embodiments, the predefined LUT can be first written into a certain number of IC devices (such as hundreds to tens of thousands, the number of which may be adjusted correspondingly based on, for example, specification requirements and/or production line environment), and these IC devices are measured to adjust the SSC settings in the predefined LUT. Then, the adjusted predefined LUT is written into the NVM of each IC device. FIG. 8 is a schematic flowchart of an SSC settings adjusting method 800 in accordance with some embodiments of the present disclosure. First, Operation S802 is performed to expand candidate SSC settings for a system scenario. Next, Operation S804 is performed to apply the candidate SSC settings to an IC device. Then, Operation S806 is performed to measure candidate SNRs of the IC device respectively under the candidate SSC settings. After Operation S806 is completed, Operation S808 is thereafter performed to select a selected SSC setting that has a highest SNR corresponding to the system scenario from the candidate SSC settings. After that, Operation S810 is performed to determine whether there is another system scenario that has not been measured or not. If there is the another system scenario that has not been measured, the flow returns to Operation S802 to Operation S808 to select the selected SSC setting that has the highest SNR corresponding to the another system scenario. After selecting the selected SSC settings that have the highest SNRs corresponding to all system scenarios, Operation S812 is performed to determine whether there is another IC device that has not been measured or not. If there is the another IC device that has not been measured, the flow returns to Operation S802 to measure all system scenarios for a next IC device. After completing the measurement of all IC devices, Operation S814 is performed to adjust the predefined LUT according to the selected SSC setting corresponding to each of the IC device and each of the system scenarios. An SSC setting corresponding to a certain system scenario in the predefined LUT can be adjusted according to the selected SSC settings corresponding to all the IC devices in the same system scenario. For example, the SSC setting corresponding to the certain system scenario may be adjusted to the selected SSC setting corresponding to a maximum number of the IC devices in the same system scenario. In other embodiments, the predefined LUT may be adjusted in a manner other than majority vote. For example, the SSC setting corresponding to the certain system scenario is adjusted to a candidate SSC setting that is closest to an average value of the selected SSC settings of all the IC devices in the same system scenario, but the present disclosure is not limited in this regard. The SSC settings corresponding to the various system scenarios stored in the predefined LUT of the NVM can be respectively substituted with the adjusted SSC settings corresponding to the various system scenarios, so as to update the predefined LUT.

By using the predefined LUT updated by performing the SSC settings adjusting method 700 or 800, a performance threshold value can be set in advance for a specific system scenario during the production stage of the IC device, and defective products lower than the performance threshold value can be rejected during testing. Additionally, after the IC device is integrated with some other chip(s) or module(s), it can be quickly identified which one(s) will generate coupling frequency and/or interferences with the wireless transmission of the IC device.

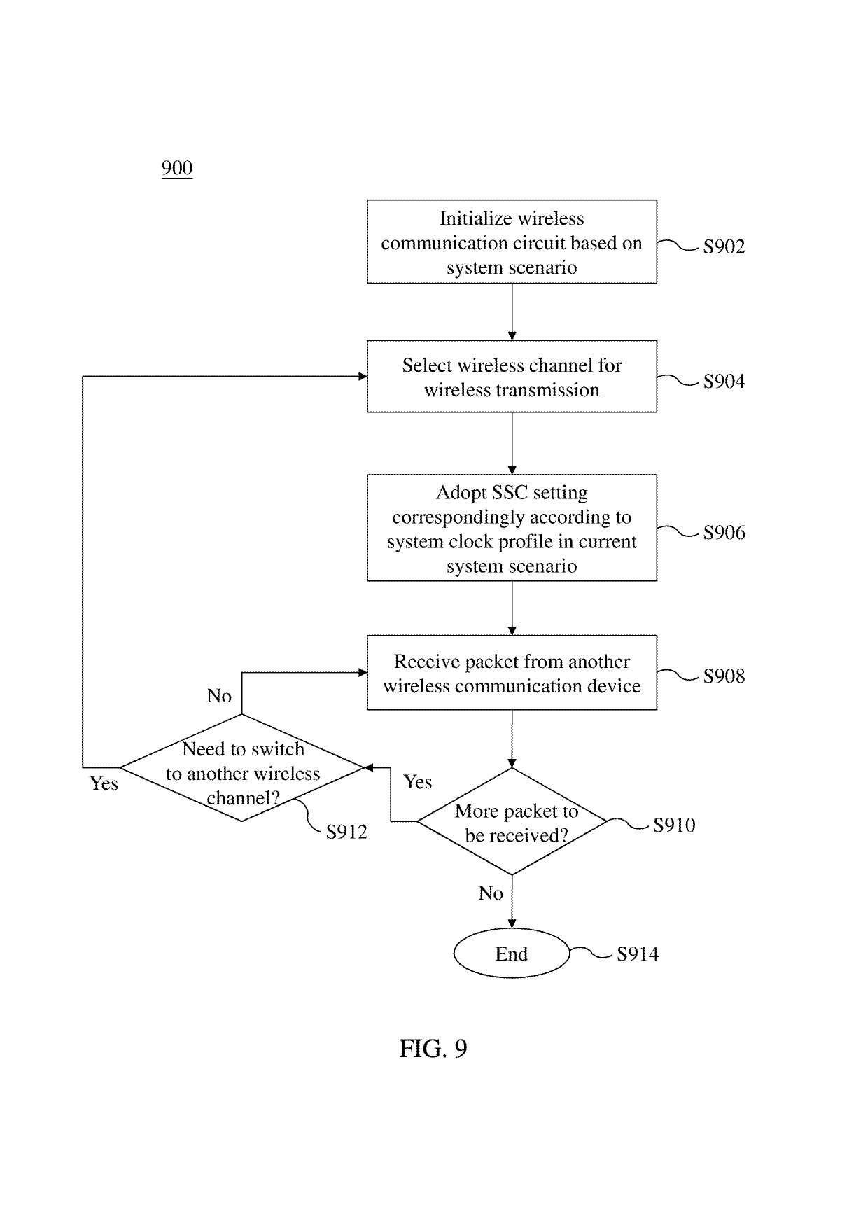

FIG. 9 is a schematic flowchart of a wireless packet receiving method 900 in accordance with some embodiments of the present disclosure. The wireless packet receiving method 900 may be performed by an IC device (such as the IC device 100 or other similar IC devices) to reduce interferences with wireless transmission by switching wireless channels. The wireless packet receiving method 900 is described as follows. First, Operation S902 is performed to initialize a wireless communication circuit (such as a Wi-Fi circuit) of the IC device based on a system scenario, and then Operation S904 is performed to select a wireless channel (such as Channel 1 of the 2.4 GHz frequency band or Channel 36 of the 5 GHz frequency band) used for wireless transmission through the wireless communication circuit. After that, Operation S906 is performed to adopt an SSC setting correspondingly according to a system clock profile in a current system scenario by referring to a predefined LUT. The predefined LUT may be stored in an NVM of the IC device. The SSC setting includes an SSC type and a spreading rate. The SSC type may be no spread, center-spread, down-spread, and up-spread, and the spreading rate is a ratio of a spread spectrum width to a center frequency of the system clock profile. Next, Operation S908 is performed to control the wireless communication circuit to receive a packet from another wireless communication device via the wireless channel. After the packet is received, Operation S910 is performed to determine whether more packet is to be received or not. If more packet is to be received, then Operation S912 is performed, otherwise, Operation S914 is performed (ending the wireless packet receiving method 900). In Operation S912, whether the wireless communication circuit needs to be switched to another wireless channel or not is determined. If yes (for example, the currently used wireless channel encounters severe interferences), the flow returns to Operation S904 to reselect a wireless channel for wireless transmission. Otherwise, the flow returns to Operation S908 to use the same wireless channel to receive the packet from the another wireless communication device.

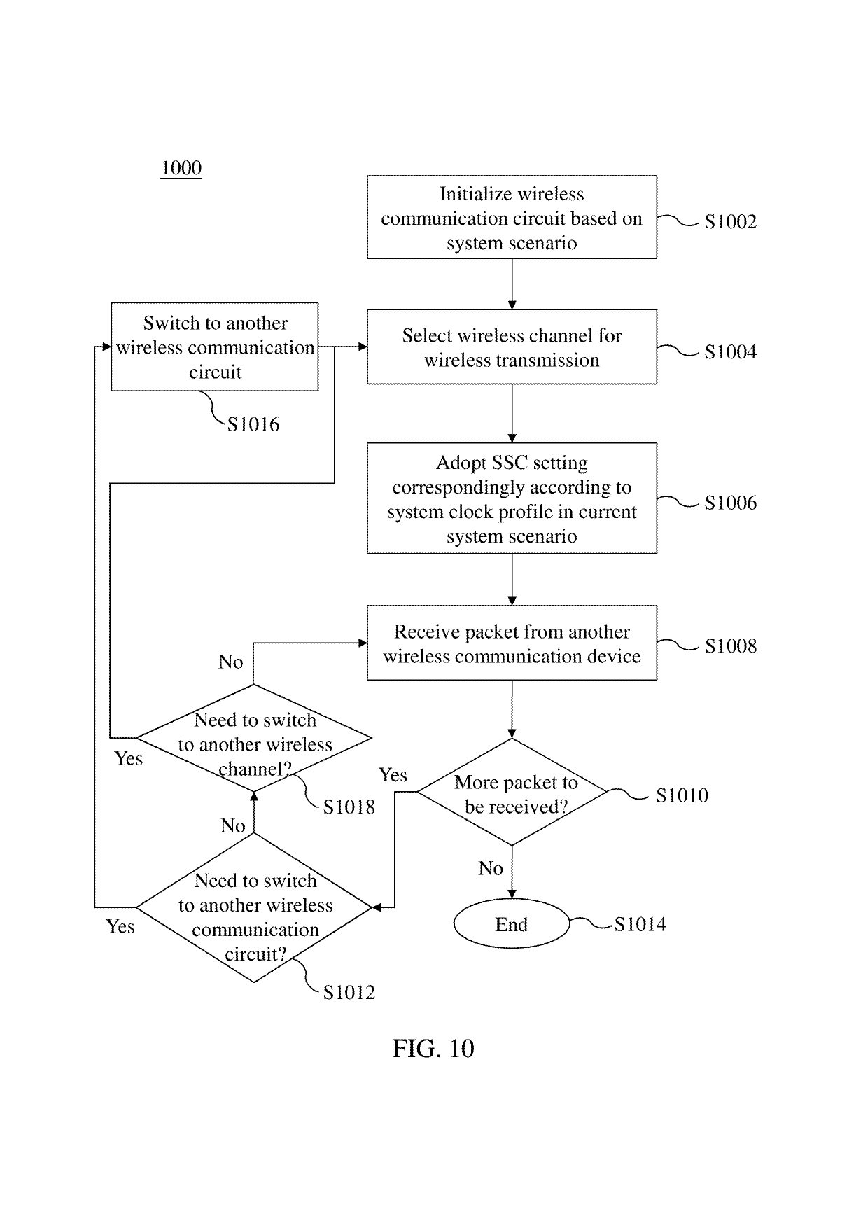

FIG. 10 is a schematic flowchart of a wireless packet receiving method 1000 in accordance with some embodiments of the present disclosure. The wireless packet receiving method 1000 may be performed by an IC device (such as the IC device 100 or other similar IC devices) to reduce interferences with wireless transmission by switching wireless channels and/or wireless communication modules. The wireless packet receiving method 1000 is described as follows. First, Operation S1002 is performed to initialize a wireless communication circuit (such as a Wi-Fi circuit) of the IC device based on a system scenario, and then Operation S1004 is performed to select a wireless channel used for wireless transmission through the wireless communication circuit. After that, Operation S1006 is performed to adopt an SSC setting correspondingly according to a system clock profile in a current system scenario by referring to a predefined LUT. Next, Operation S1008 is performed to control the wireless communication circuit to receive a packet from another wireless communication device via the wireless channel. After the packet is received, Operation S1010 is performed to determine whether more packet is to be received or not. If more packet is to be received, then Operation S1012 is performed, otherwise, Operation S1014 is performed (ending the wireless packet receiving method 1000). In Operation S1012, whether it needs to switch to another wireless communication circuit or not is determined. If yes, the flow proceeds to Operation S1016, otherwise, the flow proceeds to Operation S1018. In Operation S1016, the IC device switches the original wireless communication circuit to the another wireless communication circuit and perform initialization. After Operation S1016 is completed, the flow returns to Operation S1004 to select the wireless channel for wireless transmission. In Operation S1018, whether the wireless communication circuit needs to be switched to another wireless channel or not is determined. If yes, the flow returns to Operation S1004 to reselect the wireless channel used for wireless transmission. Otherwise, the flow returns to Operation S1008 to control the wireless communication circuit to receive the packet from the another wireless communication device via the wireless channel.

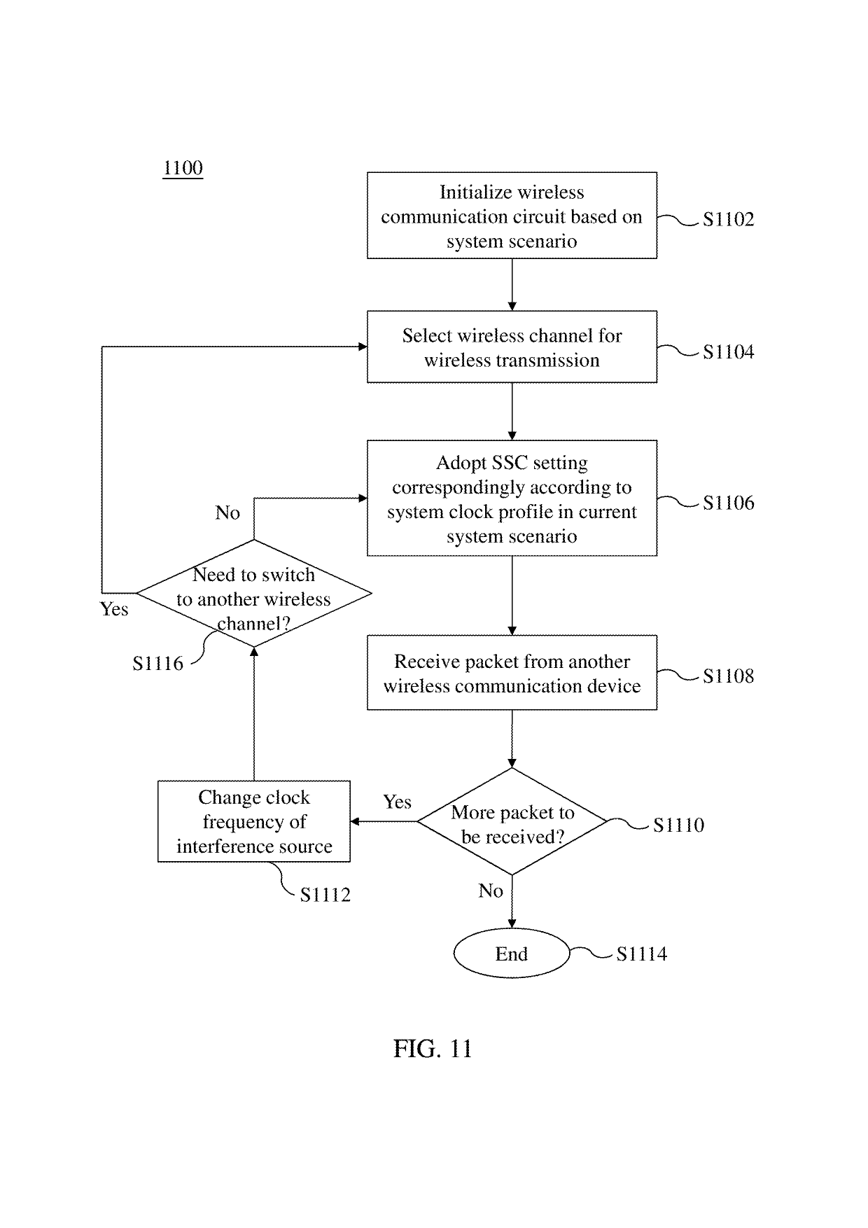

FIG. 11 is a schematic flowchart of a wireless packet receiving method 1100 in accordance with some embodiments of the present disclosure. The wireless packet receiving method 1100 may be performed by an IC device (such as the IC device 100 or other similar IC devices) to reduce interferences with wireless transmission by switching wireless channels and/or changing clock rates of interference sources. The wireless packet receiving method 1100 is described as follows. First, Operation S1102 is performed to initialize a wireless communication circuit (such as a Wi-Fi circuit) of the IC device based on a system scenario, and then Operation S1104 is performed to select a wireless channel used for wireless transmission through the wireless communication circuit. After that, Operation S1106 is performed to adopt an SSC setting correspondingly according to a system clock profile in a current system scenario by referring to a predefined LUT. The SSC setting includes an SSC type and a spreading rate. Next, Operation S1108 is performed to control the wireless communication circuit to receive a packet from another wireless communication device via the wireless channel. After the packet is received, Operation S1110 is performed to determine whether more packet is to be received or not. If more packet is to be received, then Operation S1112 is performed to change clock rates (system clock profile is therefore changed) of interference sources (including a CPU, a high-speed hardware block, such as an ISP and an encoder, and/or a high-speed interface, such as a PCIe interface or a USB3 interface, etc, and/or another hardware that can interfere with wireless transmission and reception), otherwise, Operation S1114 is performed (ending the wireless packet receiving method 1100). After Operation S1112 is completed, Operation S1116 is thereafter performed to determine whether the wireless communication circuit needs to be switched to another wireless channel or not. If yes, the flow returns to Operation S1104 to reselect the wireless channel for wireless transmission, and then Operation S1106 is performed to adopt the corresponding SSC setting according to the system clock profile that has been changed. Otherwise, the flow directly returns to Operation S1106 to adopt the corresponding SSC setting according to the system clock profile that has been changed.

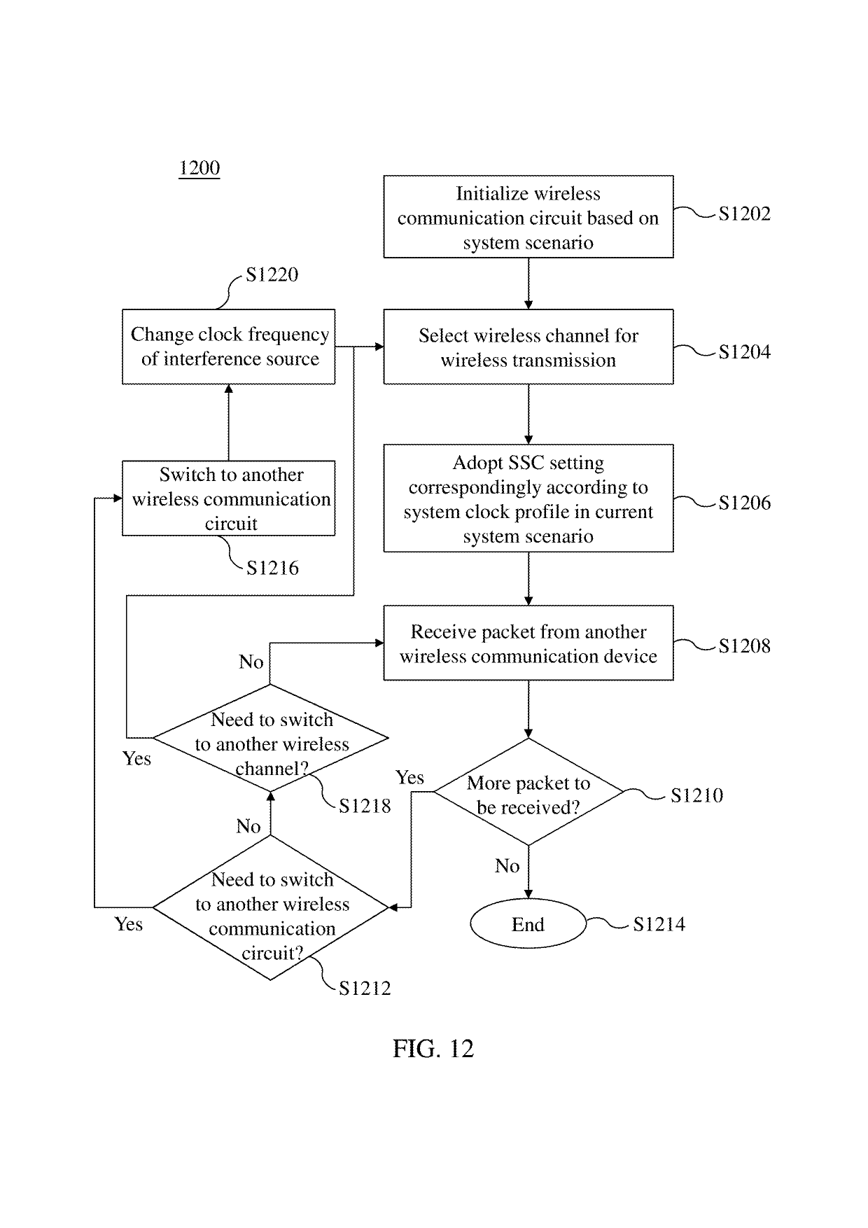

FIG. 12 is a schematic flowchart of a wireless packet receiving method 1200 in accordance with some embodiments of the present disclosure. The wireless packet receiving method 1200 may be performed by an IC device (such as the IC device 100 or other similar IC devices) to reduce interferences with wireless transmission by switching wireless channels and/or wireless communication modules. The wireless packet receiving method 1200 is described as follows. First, Operation S1202 is performed to initialize a wireless communication circuit (such as a Wi-Fi circuit) of the IC device based on a system scenario, and then Operation S1204 is performed to select a wireless channel used for wireless transmission through the wireless communication circuit. After that, Operation S1206 is performed to adopt an SSC setting correspondingly according to a system clock profile in a current system scenario by referring to a predefined LUT. Next, Operation S1208 is performed to control the wireless communication circuit to receive a packet from another wireless communication device via the wireless channel. After the packet is received, Operation S1210 is performed to determine whether more packet is to be received or not. If more packet is to be received, then Operation S1212 is performed, otherwise, Operation S1214 is performed (ending the wireless packet receiving method 1200). In Operation S1212, whether it needs to switch to another wireless communication circuit or not is determined. If yes, the flow proceeds to Operation S1216, otherwise, the flow proceeds to Operation S1218. In Operation S1216, the integrated circuit device switches the original wireless communication circuit to the another wireless communication circuit and perform initialization. After Operation S1216 is completed, Operation S1220 is performed to change clock rates (system clock profile is therefore changed) of interference sources, and then the flow returns to Operation S1204 to select the wireless channel used for wireless transmission. In Operation S1218, whether the wireless communication circuit needs to be switched to another wireless channel or not is determined. If yes, the flow returns to Operation S1204 to reselect the wireless channel used for wireless transmission. Otherwise, the flow returns to Operation S1208 to control the wireless communication circuit to receive the packet from the another wireless communication device via the wireless channel.

In summary, the present disclosure provides an SSC settings adjusting method. The SSC settings adjusting method includes: expanding candidate SSC settings for a system scenario; applying the candidate SSC settings to an IC device that stores a predefined LUT; measuring candidate SNRs of the IC device respectively under the candidate SSC settings; selecting a selected SSC setting that has a highest SNR of the candidate SNRs from the candidate SSC settings corresponding to the system scenario; and substituting an SSC setting of the predefined LUT corresponding to the system scenario with the selected SSC setting, so as to update the predefined LUT stored in the IC device. In one embodiment, the predefined LUT is established by the following operations: initializing at least one clock rate respectively corresponding to at least one hardware in a sample IC device based on a predefined system scenario of predefined system scenarios; initializing at least one affected element of the predefined system scenarios; applying the SSC settings to a spread spectrum clock generator of the IC device; measuring PSDs of the IC device in the predefined system scenarios and under the SSC settings; selecting selected PSDs respectively corresponding to the predefined system scenarios with least interferences and highest SNRs from the PSDs; and establishing the predefined LUT according to the predefined system scenarios and the SSC settings. In one embodiment, the at least one hardware includes at least one of a CPU, a high-speed hardware block, and a high-speed interface. In one embodiment, the high-speed hardware block is an ISP, an encoder, an NN circuit, an MAC circuit, or a co-processor. In one embodiment, the high-speed interface is a PCIe interface or a USB3 interface. In one embodiment, the candidate SSC settings are used for the spread spectrum clock generator to adjust the at least one clock rate of the at least one hardware. In one embodiment, the at least one affected element includes at least one of a wireless communication circuit and a wireless channel. In one embodiment, the wireless communication circuit is a Wi-Fi circuit, a Bluetooth circuit, a cellular communication circuit, a ZigBee circuit, or an NFC circuit. In one embodiment, the wireless channel is a channel of a 2.4 GHz frequency band, a 5 GHz frequency band, or a 6 GHz frequency band. In one embodiment, each of the candidate SSC settings includes an SSC type and a spreading rate. In one embodiment, the SSC type is no spread, center-spread, down-spread, or up-spread.

In summary, the present disclosure further provides a wireless packet receiving method adapted for an IC device. An NVM of the IC device stores a predefined LUT obtained by executing the above SSC settings adjusting method. The wireless packet receiving method includes: initializing a first wireless communication circuit of the IC device based on a first system scenario; selecting a first wireless channel used for wireless transmission through the first wireless communication circuit; adopting a first SSC setting correspondingly according to a first system clock profile in the first system scenario by referring to the predefined LUT; and controlling the first wireless communication circuit to receive a packet via the first wireless channel. In one embodiment, the wireless packet receiving method further includes: selecting a second wireless channel used for the wireless transmission through the first wireless communication circuit; adopting a second SSC setting correspondingly according to a second system clock profile in a second system scenario including the first wireless communication circuit and the second wireless channel by referring to the predefined LUT; and controlling the first wireless communication circuit to receive another packet via the second wireless channel. In one embodiment, the wireless packet receiving method further includes: initializing a second wireless communication circuit of the IC device; selecting a second wireless channel used for the wireless transmission through the second wireless communication circuit; adopting a second SSC setting correspondingly according to a second system clock profile in a second system scenario including the second wireless communication circuit and the second wireless channel by referring to the predefined LUT; and controlling the second wireless communication circuit to receive another packet via the second wireless channel. In one embodiment, the wireless packet receiving method further includes: changing a clock rate of an interference source in the IC device; selecting a second wireless channel used for the wireless transmission through the first wireless communication circuit; adopting a second SSC setting correspondingly according to a second system clock profile in a second system scenario including the interference source, the clock rate, the first wireless communication circuit, and the second wireless channel by referring to the predefined LUT; and controlling the first wireless communication circuit to receive another packet via the second wireless channel. In one embodiment, the wireless packet receiving method further includes: changing a clock rate of an interference source in the IC device; adopting a second SSC setting correspondingly according to a second system clock profile in a second system scenario including the interference source, the clock rate, the first wireless communication circuit, and the first wireless channel by referring to the predefined LUT; and controlling the first wireless communication circuit to receive another packet via the first wireless channel. In one embodiment, the wireless packet receiving method further includes: initializing a second wireless communication circuit of the IC device; changing a clock rate of an interference source in the IC device; selecting a second wireless channel used for the wireless transmission through the second wireless communication circuit; adopting a second SSC setting correspondingly according to a second system clock profile in a second system scenario including the interference source, the clock rate, the second wireless communication circuit, and the second wireless channel by referring to the predefined LUT; and controlling the second wireless communication circuit to receive another packet via the second wireless channel.

In summary, the present disclosure still provides an SSC settings adjusting method. The SSC settings adjusting method includes: expanding candidate SSC settings for a system scenario; applying the candidate SSC settings to each of IC devices that stores a predefined LUT; measuring candidate SNRs of each of the IC devices respectively under the candidate SSC settings; selecting a selected SSC setting that has a highest SNR of the candidate SNRs from the candidate SSC settings corresponding to the system scenario for each of the IC devices; and adjusting the predefined LUT according to the selected SSC setting corresponding to each of the IC devices, so as to update the predefined LUT stored in each of the IC devices. In one embodiment, adjusting the predefined LUT according to the selected SSC setting corresponding to each of the IC devices includes: adjusting a SSC setting corresponding to the system scenario to the selected SSC setting corresponding to a maximum number of the IC devices in the system scenario. In one embodiment, the predefined LUT is established by the following operations: initializing at least one clock rate respectively corresponding to at least one hardware in a sample IC device based on a predefined system scenario of predefined system scenarios; initializing at least one affected element of the predefined system scenarios; applying the SSC settings to a spread spectrum clock generator of the sample IC device; measuring PSDs of the sample IC device in the predefined system scenarios and under the SSC settings; selecting selected PSDs respectively corresponding to the predefined system scenarios with least interferences and highest SNRs from the PSDs; and establishing the predefined LUT according to the predefined system scenarios and the SSC settings.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A spread spectrum clocking (SSC) settings adjusting method, comprising:
expanding a plurality of candidate SSC settings for a system scenario;
applying the plurality of candidate SSC settings to an integrated circuit (IC) device that stores a predefined look-up table (LUT);
measuring a plurality of candidate signal-to-noise ratios (SNRs) of the IC device respectively under the plurality of candidate SSC settings;
selecting a selected SSC setting that has a highest SNR of the plurality of candidate SNRs from the plurality of candidate SSC settings corresponding to the system scenario; and
substituting a SSC setting of the predefined LUT corresponding to the system scenario with the selected SSC setting, so as to update the predefined LUT stored in the IC device.

2. The SSC settings adjusting method of claim 1, wherein the predefined LUT is established by the following operations:
initializing at least one clock rate respectively corresponding to at least one hardware in a sample IC device based on a predefined system scenario of a plurality of predefined system scenarios;
initializing at least one affected element of the plurality of predefined system scenarios;
applying a plurality of SSC settings to a spread spectrum clock generator of the IC device;
measuring a plurality of power spectral densities (PSDs) of the IC device in the plurality of predefined system scenarios and under the plurality of SSC settings;
selecting a plurality of selected PSDs respectively corresponding to the plurality of predefined system scenarios with least interferences and highest SNRs from the plurality of PSDs; and
establishing the predefined LUT according to the plurality of predefined system scenarios and the plurality of SSC settings.

3. The SSC settings adjusting method of claim 2, wherein the at least one hardware comprises at least one of a central processing unit (CPU), a high-speed hardware block, and a high-speed interface.

4. The SSC settings adjusting method of claim 3, wherein the high-speed hardware block is an image signal processor (ISP), an encoder, a neural network (NN) circuit, a media access control (MAC) circuit , or a co-processor.

5. The SSC settings adjusting method of claim 3, wherein the high-speed interface is a PCIe interface or a USB3 interface.

6. The SSC settings adjusting method of claim 2, wherein the plurality of candidate SSC settings are used for the spread spectrum clock generator to adjust the at least one clock rate of the at least one hardware.

7. The SSC settings adjusting method of claim 2, wherein the at least one affected element comprises at least one of a wireless communication circuit and a wireless channel.

8. The SSC settings adjusting method of claim 7, wherein the wireless communication circuit is a Wi-Fi circuit, a Bluetooth circuit, a cellular communication circuit, a ZigBee circuit, or a near-field communication (NFC) circuit.

9. The SSC settings adjusting method of claim 7, wherein the wireless channel is a channel of a 2.4 GHz frequency band, a 5 GHz frequency band, or a 6 GHz frequency band.

10. The SSC settings adjusting method of claim 1, wherein each of the plurality of candidate SSC settings comprises a SSC type and a spreading rate.

11. The SSC settings adjusting method of claim 10, wherein the SSC type is no spread, center-spread, down-spread, or up-spread.

12. A wireless packet receiving method adapted for an IC device, a non-volatile memory (NVM) of the IC device storing a predefined LUT obtained by executing the SSC settings adjusting method of claim 1, the wireless packet receiving method comprising:
initializing a first wireless communication circuit of the IC device based on a first system scenario;
selecting a first wireless channel used for wireless transmission through the first wireless communication circuit;
adopting a first SSC setting correspondingly according to a first system clock profile in the first system scenario by referring to the predefined LUT; and
controlling the first wireless communication circuit to receive a packet via the first wireless channel.

13. The wireless packet receiving method of claim 12, further comprising:
selecting a second wireless channel used for the wireless transmission through the first wireless communication circuit;
adopting a second SSC setting correspondingly according to a second system clock profile in a second system scenario comprising the first wireless communication circuit and the second wireless channel by referring to the predefined LUT; and
controlling the first wireless communication circuit to receive another packet via the second wireless channel.

14. The wireless packet receiving method of claim 12, further comprising:
initializing a second wireless communication circuit of the IC device;
selecting a second wireless channel used for the wireless transmission through the second wireless communication circuit;
adopting a second SSC setting correspondingly according to a second system clock profile in a second system scenario comprising the second wireless communication circuit and the second wireless channel by referring to the predefined LUT; and
controlling the second wireless communication circuit to receive another packet via the second wireless channel.

15. The wireless packet receiving method of claim 12, further comprising:
changing a clock rate of an interference source in the IC device;
selecting a second wireless channel used for the wireless transmission through the first wireless communication circuit;
adopting a second SSC setting correspondingly according to a second system clock profile in a second system scenario comprising the interference source, the clock rate, the first wireless communication circuit, and the second wireless channel by referring to the predefined LUT; and
controlling the first wireless communication circuit to receive another packet via the second wireless channel.

16. The wireless packet receiving method of claim 12, further comprising:
changing a clock rate of an interference source in the IC device;
adopting a second SSC setting correspondingly according to a second system clock profile in a second system scenario comprising the interference source, the clock rate, the first wireless communication circuit, and the first wireless channel by referring to the predefined LUT; and
controlling the first wireless communication circuit to receive another packet via the first wireless channel.

17. The wireless packet receiving method of claim 12, further comprising:
initializing a second wireless communication circuit of the IC device;
changing a clock rate of an interference source in the IC device;
selecting a second wireless channel used for the wireless transmission through the second wireless communication circuit;
adopting a second SSC setting correspondingly according to a second system clock profile in a second system scenario comprising the interference source, the clock rate, the second wireless communication circuit, and the second wireless channel by referring to the predefined LUT; and
controlling the second wireless communication circuit to receive another packet via the second wireless channel.

18. An SSC settings adjusting method, comprising:
expanding a plurality of candidate SSC settings for a system scenario;
applying the plurality of candidate SSC settings to each of a plurality of IC devices that stores a predefined LUT;
measuring a plurality of candidate SNRs of each of the plurality of IC devices respectively under the plurality of candidate SSC settings;
selecting a selected SSC setting that has a highest SNR of the plurality of candidate SNRs from the plurality of candidate SSC settings corresponding to the system scenario for each of the plurality of IC devices; and
adjusting the predefined LUT according to the selected SSC setting corresponding to each of the plurality of IC devices, so as to update the predefined LUT stored in each of the plurality of IC devices.

19. The SSC settings adjusting method of claim 18, wherein adjusting the predefined LUT according to the selected SSC setting corresponding to each of the plurality of IC devices comprises:
adjusting an SSC setting corresponding to the system scenario to the selected SSC setting corresponding to a maximum number of the plurality of IC devices in the system scenario.

20. The SSC settings adjusting method of claim 18, wherein the predefined LUT is established by the following operations:
initializing at least one clock rate respectively corresponding to at least one hardware in a sample IC device based on a predefined system scenario of a plurality of predefined system scenarios;
initializing at least one affected element of the plurality of predefined system scenarios;
applying a plurality of SSC settings to a spread spectrum clock generator of the sample IC device;
measuring a plurality of PSDs of the sample IC device in the plurality of predefined system scenarios and under the plurality of SSC settings;
selecting a plurality of selected PSDs respectively corresponding to the plurality of predefined system scenarios with least interferences and highest SNRs from the plurality of PSDs; and
establishing the predefined LUT according to the plurality of predefined system scenarios and the plurality of SSC settings.
